(19) United States
(12) Patent Application Publication
(10) Pub. No.: US 2024/0355341 A1
(43) Pub. Date: Oct. 24, 2024

(54) Creating Spatial Audio Stream from Audio Objects with Spatial Extent

(71) Applicant: Nokia Technologies Oy, Espoo (FI)

(72) Inventors: Mikko-Ville LAITINEN, Espoo (FI); Tapani PIHLAJAKUJA, Kellokoski (FI)

(21) Appl. No.: 18/574,918

(22) PCT Filed: Jun. 16, 2022
(86) PCT No.: PCT/FI2022/050419

§ 371 Date: Dec. 28, 2023

(30) Foreign Application Priority Data
Jun. 30, 2021 (GB) 2109443.8

(51) Int. Cl. G10L 19/008

(52) U.S. Cl. CPC G10L 19/008

(57) ABSTRACT

An apparatus for spatial audio encoding including circuitry configured to: obtain a first spatial audio stream of a first spatial audio format configured to be encoded with a low bitrate, wherein the first spatial audio stream includes an audio signal and a first metadata; obtain a second and different spatial audio stream of a second spatial audio format, wherein the second spatial audio stream includes a second audio signal and a second metadata; convert the second spatial audio format into the first spatial audio format to encode a converted second spatial audio stream with the low bitrate, wherein the converted spatial audio stream represents spatial audio properties of the second spatial audio stream; combine the first spatial audio stream and the converted second spatial audio stream to generate a combined spatial audio stream; and encode the combined spatial audio stream.

### FIELD

The present application relates to apparatus and methods for creating spatial audio stream from audio objects with spatial extent, but not exclusively for creating spatial audio stream from audio objects with spatial extent for mobile phone systems.

### BACKGROUND

Immersive audio codecs are being implemented supporting a multitude of operating points ranging from a low bit rate operation to transparency. An example of such a codec is the Immersive Voice and Audio Services (IVAS) codec which is being designed to be suitable for use over a communications network such as a 3GPP 4G/5G network including use in such immersive services as for example immersive voice and audio for virtual reality (VR). This audio codec is expected to handle the encoding, decoding and rendering of speech, music and generic audio. It is furthermore expected to support channel-based audio and scene-based audio inputs including spatial information about the sound field and sound sources.

Input signals can be presented to the IVAS encoder in one of a number of supported formats (and in some allowed combinations of the formats). For example a mono audio signal (without metadata) may be encoded using an Enhanced Voice Service (EVS) encoder. Other input formats may utilize new IVAS encoding tools. One input format proposed for IVAS is the Metadata-assisted spatial audio (MASA) format, where the encoder may utilize, e.g., a combination of mono and stereo encoding tools and metadata encoding tools for efficient transmission of the format.

The use of “Audio objects” is another example of an input format proposed for IVAS. In this input format the scene is defined by a number (1−N) of audio objects (where N is, e.g., 5). Each of the objects have an individual audio signal and some metadata describing its (spatial) features. The metadata may be a parametric representation of audio object and may include such parameters as the direction of the audio object (e.g., azimuth and elevation angles). Other examples include the distance, the spatial extent, and the gain of the object.

IVAS is being planned to support combinations of inputs. As an example, there may be a combination of a MASA input with an audio object(s) input. IVAS should be able to transmit them both simultaneously.

As the IVAS codec is expected to operate on various bit rates ranging from very low bit rates (about 13 kb/s) to relatively high bit rates (about 500 kb/s), various strategies are needed for the compression of the audio signals and the spatial metadata. For example, in the case where the input comprises multiple objects and MASA input streams, there are several audio channels to transmit. This can therefore create a situation where, especially at lower bitrates, it may not be possible to transmit all the audio signals separately.

Being able to convert audio object signals with spatial extent to spatial audio streams (such as MASA or any other suitable stream) that can be used to transmit the audio objects with low bitrate (e.g., around 10-40 kbps) and then be used to render spatial audio signals with the desired extents is desired.

### SUMMARY

There is provided according to a first aspect an apparatus, for spatial audio encoding, the apparatus comprising means configured to: obtain a first spatial audio stream of a first spatial audio format configured to be encoded with a low bitrate, wherein the first spatial audio stream comprises at least one audio signal and at least one first metadata; obtain a second spatial audio stream of a second spatial audio format, the second spatial audio format being different from the first spatial audio format, wherein the second spatial audio stream comprises at least one second audio signal and at least one second metadata; convert the second spatial audio format into the first spatial audio format so as to encode a converted second spatial audio stream with the low bitrate, wherein the converted spatial audio stream, at least in part represents spatial audio properties of the second spatial audio stream; combine the first spatial audio stream and the converted second spatial audio stream so as to generate a combined spatial audio stream for encoding with the low bitrate; and encode the combined spatial audio stream.

The first spatial audio format may be a metadata assisted spatial audio format, wherein the at least one first metadata may be at least one spatial parameter.

The at least one spatial parameter may comprise at least one of: at least one direction parameter; at least one energy ratio parameter; and at least one coherence parameter.

The apparatus may comprise at least two microphones, and the means configured to obtain the first spatial audio stream of the first spatial audio format may be further configured to generate the first spatial audio stream of the first spatial audio format based on at least two microphone audio signals from the at least two microphones.

The second spatial audio format may be an object audio format, wherein the at least one second metadata may be at least one object spatial parameter.

The at least one object spatial parameter may comprise at least one of: at least one object direction parameter; at least one object energy ratio parameter; and at least one object spatial extent parameter.

The means may be configured to receive at least one external microphone audio signal, and wherein the means configured to obtain the second spatial audio stream of the second spatial audio format may be configured to generate the second spatial audio stream based on the at least one external microphone audio signal.

The means configured to convert the second spatial audio format into the first spatial audio format may be configured to: determine whether the second spatial audio stream of the second spatial audio format has a spatial extent; and convert the second spatial audio format into the first spatial audio format based on the determination of whether the second spatial audio stream of the second spatial audio format has a spatial extent.

The second spatial audio stream of the second spatial audio format may have a spatial extent and the means configured to convert the second spatial audio format into the first spatial audio format based on the determination of whether the second spatial audio stream of the second spatial audio format has a spatial extent may be further configured to: obtain an initial converted first spatial audio format direction parameter based on an object direction parameter from the second spatial audio format; and modify the initial converted first spatial audio format direction parameter to generate a converted first audio format direction parameter based on the spatial extent from the second spatial audio stream.

The means configured to modify the initial converted first spatial audio format direction parameter to generate a converted first audio format direction parameter based on the spatial extent from the second spatial audio stream may be configured to determine the converted first audio format direction parameter based on modification angle applied to the initial converted first spatial audio format direction parameter, wherein the modification angle may be based on an extent angle of the spatial extent, a direction fluctuation constant, and a random or pseudo-random distribution generated value.

The means configured to convert the second spatial audio format into the first spatial audio format based on the determination of whether the second spatial audio stream of the second spatial audio format has a spatial extent may be further configured to obtain a converted first spatial audio format energy ratio parameter based on the spatial extent from the second spatial audio stream.

The means configured to obtain the converted first spatial audio format energy ratio parameter based on the spatial extent from the second spatial audio stream may be further configured to determine the converted first spatial audio format energy ratio parameter based on a decrease profile generated by a ratio between an extent angle of the spatial extent and an extent angle limit.

The means configured to convert the second spatial audio format into the first spatial audio format based on the determination of whether the second spatial audio stream of the second spatial audio format has a spatial extent may be further configured to obtain a converted first spatial audio format coherence parameter based on the spatial extent from the second spatial audio stream.

The means configured to obtain a converted first spatial audio format coherence parameter based on the spatial extent from the second spatial audio stream may be configured to determine a spread coherence parameter, such that the spread coherence parameter may be increased based on an extent angle of the spatial extent and clamped to a maximum value.

The means configured to obtain a converted first spatial audio format coherence parameter based on the spatial extent from the second spatial audio stream may be configured to determine a surround coherence parameter, such that the surround coherence parameter may be increased based on an extent angle of the spatial extent.

The second spatial audio stream of the second spatial audio format may have no spatial extent or may be a point-like object and the means configured to convert the second spatial audio format into the first spatial audio format based on the determination of whether the second spatial audio stream of the second spatial audio format has a spatial extent may be further configured to: generate a first order ambisonic audio signal from the at least one second audio signal and the at least one second metadata, wherein the at least one second format audio signal may be a point-like object audio signal and the at least one second metadata may be a point-like object direction parameter; and analyze the first order ambisonic audio signal.

The means configured to generate a first order ambisonic audio signal from the at least one second audio signal and the at least one second metadata, wherein the at least one second format audio signal may be a point-like object audio signal and the at least one second metadata may be a point-like object direction parameter may be configured to: convert each separate point-like object to separate first order ambisonic audio signals; and sum the separate first order ambisonic audio signals together to form a combined first order ambisonic audio signal.

The means configured to analyze the first order ambisonic audio signal May be configured to: determine an intensity-related variable from the combined first order ambisonic audio signal; determine a converted first spatial audio format direction parameter direction parameter based on the intensity-related variable; determine a converted first spatial audio format energy ratio parameter based on the intensity-related variable and the combined first order ambisonic audio signal; set a converted first spatial audio format spread coherence parameter to zero; and set a converted first spatial audio format surround coherence parameter to zero.

The second spatial audio stream of the second spatial audio format may be a single point-like object and the means configured to convert the second spatial audio format into the first spatial audio format based on the determination of whether the second spatial audio stream of the second spatial audio format may have a spatial extent may be further configured to: set a converted first spatial audio format direction parameter direction parameter to a single point-like object at least one direction parameter; set a converted first spatial audio format energy ratio parameter to one; set a converted first spatial audio format spread coherence parameter to zero; and set a converted first spatial audio format surround coherence parameter to zero.

The means configured to combine the first spatial audio stream and the converted second spatial audio stream so as to generate a combined spatial audio stream for encoding with the low bitrate may be configured to mix the first spatial audio stream and the converted second spatial audio stream.

The means may be further configured to transmit the encoded combined spatial audio stream.

According to a second aspect there is provided a method for an apparatus, for spatial audio encoding, the method comprising: obtaining a first spatial audio stream of a first spatial audio format configured to be encoded with a low bitrate, wherein the first spatial audio stream comprises at least one audio signal and at least one first metadata; obtaining a second spatial audio stream of a second spatial audio format, the second spatial audio format being different from the first spatial audio format, wherein the second spatial audio stream comprises at least one second audio signal and at least one second metadata; converting the second spatial audio format into the first spatial audio format so as to encode a converted second spatial audio stream with the low bitrate, wherein the converted spatial audio stream, at least in part represents spatial audio properties of the second spatial audio stream; combining the first spatial audio stream and the converted second spatial audio stream so as to generate a combined spatial audio stream for encoding with the low bitrate; and encode the combined spatial audio stream.

The first spatial audio format may be a metadata assisted spatial audio format, wherein the at least one first metadata may be at least one spatial parameter.

The at least one spatial parameter may comprise at least one of: at least one direction parameter; at least one energy ratio parameter; and at least one coherence parameter.

The apparatus may comprise at least two microphones, and obtaining the first spatial audio stream of the first spatial audio format may further configured to generate the first spatial audio stream of the first spatial audio format based on at least two microphone audio signals from the at least two microphones.

The second spatial audio format may be an object audio format, wherein the at least one second metadata may be at least one object spatial parameter.

The at least one object spatial parameter may comprise at least one of: at least one object direction parameter; at least one object energy ratio parameter; and at least one object spatial extent parameter.

The method may comprise receiving at least one external microphone audio signal, and wherein obtaining the second spatial audio stream of the second spatial audio format may comprise generating the second spatial audio stream based on the at least one external microphone audio signal.

Converting the second spatial audio format into the first spatial audio format may comprise: determining whether the second spatial audio stream of the second spatial audio format has a spatial extent; and converting the second spatial audio format into the first spatial audio format based on the determination of whether the second spatial audio stream of the second spatial audio format has a spatial extent.

The second spatial audio stream of the second spatial audio format may have a spatial extent and converting the second spatial audio format into the first spatial audio format based on the determination of whether the second spatial audio stream of the second spatial audio format has a spatial extent may further comprise: obtaining an initial converted first spatial audio format direction parameter based on an object direction parameter from the second spatial audio format; and modifying the initial converted first spatial audio format direction parameter to generate a converted first audio format direction parameter based on the spatial extent from the second spatial audio stream.

Modifying the initial converted first spatial audio format direction parameter to generate a converted first audio format direction parameter based on the spatial extent from the second spatial audio stream may comprise determining the converted first audio format direction parameter based on modification angle applied to the initial converted first spatial audio format direction parameter, wherein the modification angle may be based on an extent angle of the spatial extent, a direction fluctuation constant, and a random or pseudo-random distribution generated value.

Converting the second spatial audio format into the first spatial audio format based on the determination of whether the second spatial audio stream of the second spatial audio format has a spatial extent may further comprise obtaining a converted first spatial audio format energy ratio parameter based on the spatial extent from the second spatial audio stream.

Obtaining the converted first spatial audio format energy ratio parameter based on the spatial extent from the second spatial audio stream may further comprise determining the converted first spatial audio format energy ratio parameter based on a decrease profile generated by a ratio between an extent angle of the spatial extent and an extent angle limit.

Converting the second spatial audio format into the first spatial audio format based on the determination of whether the second spatial audio stream of the second spatial audio format has a spatial extent may further comprise obtaining a converted first spatial audio format coherence parameter based on the spatial extent from the second spatial audio stream.

Obtaining a converted first spatial audio format coherence parameter based on the spatial extent from the second spatial audio stream may comprise determining a spread coherence parameter, such that the spread coherence parameter may be increased based on an extent angle of the spatial extent and clamped to a maximum value.

Obtaining a converted first spatial audio format coherence parameter based on the spatial extent from the second spatial audio stream may comprise determining a surround coherence parameter, such that the surround coherence parameter may be increased based on an extent angle of the spatial extent.

The second spatial audio stream of the second spatial audio format may have no spatial extent or may be a point-like object and converting the second spatial audio format into the first spatial audio format based on the determination of whether the second spatial audio stream of the second spatial audio format has a spatial extent may comprise: generating a first order ambisonic audio signal from the at least one second audio signal and the at least one second metadata, wherein the at least one second format audio signal may be a point-like object audio signal and the at least one second metadata may be a point-like object direction parameter; and analyze the first order ambisonic audio signal.

Generating a first order ambisonic audio signal from the at least one second audio signal and the at least one second metadata, wherein the at least one second format audio signal may be a point-like object audio signal and the at least one second metadata may be a point-like object direction parameter may comprise: converting each separate point-like object to separate first order ambisonic audio signals; and summing the separate first order ambisonic audio signals together to form a combined first order ambisonic audio signal.

Analyzing the first order ambisonic audio signal may comprise: determining an intensity-related variable from the combined first order ambisonic audio signal; determining a converted first spatial audio format direction parameter direction parameter based on the intensity-related variable; determining a converted first spatial audio format energy ratio parameter based on the intensity-related variable and the combined first order ambisonic audio signal; setting a converted first spatial audio format spread coherence parameter to zero; and setting a converted first spatial audio format surround coherence parameter to zero.

The second spatial audio stream of the second spatial audio format may be a single point-like object and converting the second spatial audio format into the first spatial audio format based on the determination of whether the second spatial audio stream of the second spatial audio format may have a spatial extent may comprise: setting a converted first spatial audio format direction parameter direction parameter to a single point-like object at least one direction parameter; setting a converted first spatial audio format energy ratio parameter to one; setting a converted first spatial audio format spread coherence parameter to zero; and setting a converted first spatial audio format surround coherence parameter to zero.

Combining the first spatial audio stream and the converted second spatial audio stream so as to generate a combined spatial audio stream for encoding with the low bitrate may comprise mixing the first spatial audio stream and the converted second spatial audio stream.

The method may be further comprise transmitting the encoded combined spatial audio stream.

According to a third aspect there is provided an apparatus for spatial audio encoding, the apparatus comprising at least one processor and at least one memory including a computer program code, the at least one memory and the computer program code configured to, with the at least one processor, cause the apparatus at least to: obtain a first spatial audio stream of a first spatial audio format configured to be encoded with a low bitrate, wherein the first spatial audio stream comprises at least one audio signal and at least one first metadata; obtain a second spatial audio stream of a second spatial audio format, the second spatial audio format being different from the first spatial audio format, wherein the second spatial audio stream comprises at least one second audio signal and at least one second metadata; convert the second spatial audio format into the first spatial audio format so as to encode a converted second spatial audio stream with the low bitrate, wherein the converted spatial audio stream, at least in part represents spatial audio properties of the second spatial audio stream; combine the first spatial audio stream and the converted second spatial audio stream so as to generate a combined spatial audio stream for encoding with the low bitrate; and encode the combined spatial audio stream.

The first spatial audio format may be a metadata assisted spatial audio format, wherein the at least one first metadata may be at least one spatial parameter.

The at least one spatial parameter may comprise at least one of: at least one direction parameter; at least one energy ratio parameter; and at least one coherence parameter.

The apparatus may comprise at least two microphones, and the apparatus caused to obtain the first spatial audio stream of the first spatial audio format may be further caused to generate the first spatial audio stream of the first spatial audio format based on at least two microphone audio signals from the at least two microphones.

The second spatial audio format may be an object audio format, wherein the at least one second metadata may be at least one object spatial parameter.

The at least one object spatial parameter may comprise at least one of: at least one object direction parameter; at least one object energy ratio parameter; and at least one object spatial extent parameter.

The apparatus may be further caused to receive at least one external microphone audio signal, and wherein the apparatus caused to obtain the second spatial audio stream of the second spatial audio format may be caused to generate the second spatial audio stream based on the at least one external microphone audio signal.

The apparatus caused to convert the second spatial audio format into the first spatial audio format may be caused to: determine whether the second spatial audio stream of the second spatial audio format has a spatial extent; and convert the second spatial audio format into the first spatial audio format based on the determination of whether the second spatial audio stream of the second spatial audio format has a spatial extent.

The second spatial audio stream of the second spatial audio format may have a spatial extent and the apparatus caused to convert the second spatial audio format into the first spatial audio format based on the determination of whether the second spatial audio stream of the second spatial audio format has a spatial extent may be further caused to: obtain an initial converted first spatial audio format direction parameter based on an object direction parameter from the second spatial audio format; and modify the initial converted first spatial audio format direction parameter to generate a converted first audio format direction parameter based on the spatial extent from the second spatial audio stream.

The apparatus caused to modify the initial converted first spatial audio format direction parameter to generate a converted first audio format direction parameter based on the spatial extent from the second spatial audio stream may be caused to determine the converted first audio format direction parameter based on modification angle applied to the initial converted first spatial audio format direction parameter, wherein the modification angle may be based on an extent angle of the spatial extent, a direction fluctuation constant, and a random or pseudo-random distribution generated value.

The apparatus caused to convert the second spatial audio format into the first spatial audio format based on the determination of whether the second spatial audio stream of the second spatial audio format has a spatial extent may be further caused to obtain a converted first spatial audio format energy ratio parameter based on the spatial extent from the second spatial audio stream.

The apparatus caused to obtain the converted first spatial audio format energy ratio parameter based on the spatial extent from the second spatial audio stream may be further caused to determine the converted first spatial audio format energy ratio parameter based on a decrease profile generated by a ratio between an extent angle of the spatial extent and an extent angle limit.

The apparatus caused to convert the second spatial audio format into the first spatial audio format based on the determination of whether the second spatial audio stream of the second spatial audio format has a spatial extent may be further caused to obtain a converted first spatial audio format coherence parameter based on the spatial extent from the second spatial audio stream.

The apparatus caused to obtain a converted first spatial audio format coherence parameter based on the spatial extent from the second spatial audio stream may be caused to determine a spread coherence parameter, such that the spread coherence parameter may be increased based on an extent angle of the spatial extent and clamped to a maximum value.

The apparatus caused to obtain a converted first spatial audio format coherence parameter based on the spatial extent from the second spatial audio stream may be caused to determine a surround coherence parameter, such that the surround coherence parameter may be increased based on an extent angle of the spatial extent.

The second spatial audio stream of the second spatial audio format may have no spatial extent or may be a point-like object and the apparatus caused to convert the second spatial audio format into the first spatial audio format based on the determination of whether the second spatial audio stream of the second spatial audio format has a spatial extent may be further caused to: generate a first order ambisonic audio signal from the at least one second audio signal and the at least one second metadata, wherein the at least one second format audio signal may be a point-like object audio signal and the at least one second metadata may be a point-like object direction parameter; and analyze the first order ambisonic audio signal.

The apparatus caused to generate a first order ambisonic audio signal from the at least one second audio signal and the at least one second metadata, wherein the at least one second format audio signal may be a point-like object audio signal and the at least one second metadata may be a point-like object direction parameter may be caused to: convert each separate point-like object to separate first order ambisonic audio signals; and sum the separate first order ambisonic audio signals together to form a combined first order ambisonic audio signal.

The apparatus caused to analyze the first order ambisonic audio signal may be caused to: determine an intensity-related variable from the combined first order ambisonic audio signal; determine a converted first spatial audio format direction parameter direction parameter based on the intensity-related variable; determine a converted first spatial audio format energy ratio parameter based on the intensity-related variable and the combined first order ambisonic audio signal; set a converted first spatial audio format spread coherence parameter to zero; and set a converted first spatial audio format surround coherence parameter to zero.

The second spatial audio stream of the second spatial audio format may be a single point-like object and the apparatus caused to convert the second spatial audio format into the first spatial audio format based on the determination of whether the second spatial audio stream of the second spatial audio format may have a spatial extent may be further caused to: set a converted first spatial audio format direction parameter direction parameter to a single point-like object at least one direction parameter; set a converted first spatial audio format energy ratio parameter to one; set a converted first spatial audio format spread coherence parameter to zero; and set a converted first spatial audio format surround coherence parameter to zero.

The apparatus caused to combine the first spatial audio stream and the converted second spatial audio stream so as to generate a combined spatial audio stream for encoding with the low bitrate may be caused to mix the first spatial audio stream and the converted second spatial audio stream.

The apparatus may be further caused to transmit the encoded combined spatial audio stream.

According to a fourth aspect there is provided an apparatus comprising: means for obtaining a first spatial audio stream of a first spatial audio format configured to be encoded with a low bitrate, wherein the first spatial audio stream comprises at least one audio signal and at least one first metadata; means for obtaining a second spatial audio stream of a second spatial audio format, the second spatial audio format being different from the first spatial audio format, wherein the second spatial audio stream comprises at least one second audio signal and at least one second metadata; means for converting the second spatial audio format into the first spatial audio format so as to encode a converted second spatial audio stream with the low bitrate, wherein the converted spatial audio stream, at least in part represents spatial audio properties of the second spatial audio stream; means for combining the first spatial audio stream and the converted second spatial audio stream so as to generate a combined spatial audio stream for encoding with the low bitrate; and encode the combined spatial audio stream.

According to a fifth aspect there is provided a computer program comprising instructions [or a computer readable medium comprising program instructions] for causing an apparatus to perform at least the following: obtain a first spatial audio stream of a first spatial audio format configured to be encoded with a low bitrate, wherein the first spatial audio stream comprises at least one audio signal and at least one first metadata; obtain a second spatial audio stream of a second spatial audio format, the second spatial audio format being different from the first spatial audio format, wherein the second spatial audio stream comprises at least one second audio signal and at least one second metadata; convert the second spatial audio format into the first spatial audio format so as to encode a converted second spatial audio stream with the low bitrate, wherein the converted spatial audio stream, at least in part represents spatial audio properties of the second spatial audio stream; combine the first spatial audio stream and the converted second spatial audio stream so as to generate a combined spatial audio stream for encoding with the low bitrate; and encode the combined spatial audio stream.

According to a sixth aspect there is provided a non-transitory computer readable medium comprising program instructions for causing an apparatus to perform at least the following: obtain a first spatial audio stream of a first spatial audio format configured to be encoded with a low bitrate, wherein the first spatial audio stream comprises at least one audio signal and at least one first metadata; obtain a second spatial audio stream of a second spatial audio format, the second spatial audio format being different from the first spatial audio format, wherein the second spatial audio stream comprises at least one second audio signal and at least one second metadata; convert the second spatial audio format into the first spatial audio format so as to encode a converted second spatial audio stream with the low bitrate, wherein the converted spatial audio stream, at least in part represents spatial audio properties of the second spatial audio stream; combine the first spatial audio stream and the converted second spatial audio stream so as to generate a combined spatial audio stream for encoding with the low bitrate; and encode the combined spatial audio stream.

According to a seventh aspect there is provided an apparatus comprising: obtaining circuitry configured to obtain a first spatial audio stream of a first spatial audio format configured to be encoded with a low bitrate, wherein the first spatial audio stream comprises at least one audio signal and at least one first metadata; obtaining circuitry configured to obtain a second spatial audio stream of a second spatial audio format, the second spatial audio format being different from the first spatial audio format, wherein the second spatial audio stream comprises at least one second audio signal and at least one second metadata; converting circuitry configured to convert the second spatial audio format into the first spatial audio format so as to encode a converted second spatial audio stream with the low bitrate, wherein the converted spatial audio stream, at least in part represents spatial audio properties of the second spatial audio stream; combining circuitry configured to combine the first spatial audio stream and the converted second spatial audio stream so as to generate a combined spatial audio stream for encoding with the low bitrate; and encode the combined spatial audio stream.

According to an eighth aspect there is provided a computer readable medium comprising program instructions for causing an apparatus to perform at least the following: obtain a first spatial audio stream of a first spatial audio format configured to be encoded with a low bitrate, wherein the first spatial audio stream comprises at least one audio signal and at least one first metadata; obtain a second spatial audio stream of a second spatial audio format, the second spatial audio format being different from the first spatial audio format, wherein the second spatial audio stream comprises at least one second audio signal and at least one second metadata; convert the second spatial audio format into the first spatial audio format so as to encode a converted second spatial audio stream with the low bitrate, wherein the converted spatial audio stream, at least in part represents spatial audio properties of the second spatial audio stream; combine the first spatial audio stream and the converted second spatial audio stream so as to generate a combined spatial audio stream for encoding with the low bitrate; and encode the combined spatial audio stream.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows schematically a system of apparatus suitable for implementing some embodiments;

FIG. 2 shows a flow diagram of the operation of the apparatus shown in FIG. 1 according to some embodiments;

FIG. 3 shows schematically an example of the converter as shown in FIG. 1 according to some embodiments;

FIG. 4 shows a flow diagram of the operations of the example encoder shown in FIG. 3 according to some embodiments;

FIG. 5 shows schematically an example implementation apparatus according to some embodiments; and

FIG. 6 shows schematically an example device suitable for implementing the apparatus shown herein.

### EMBODIMENTS OF THE APPLICATION

The concept as discussed herein in further detail with respect to the following embodiments is related to parametric spatial audio encoding. In the following examples an IVAS codec is used to show practical implementations or examples of the concept. However it would be appreciated that the embodiments presented herein may be extended to other codecs without inventive input.

The concept as discussed herein in further detail in the following embodiments is one of converting audio object signals with spatial extent to spatial audio streams and which can be used to render spatial audio signals with the desired extents.

The audio object signal for the following examples can be understood to be an audio signal associated with object metadata and such object metadata for the following examples may consist of one or more elements or parameters which can assist to define the audio signal. For example in some embodiments the audio objects with spatial extent comprise (as a minimum) a direction parameter and a spatial extent parameter.

Although methods have been proposed for synthesizing spatial extent for audio objects, these methods assume that the audio signal of each object is available alongside with metadata containing parameters stating the position and the extent of each object.

However in the case of a codec running low-bit-rate compression, objects may not be transmitted individually. For example an IVAS codec may be expected to support bitrates as low as about 10 kbps and it is commonly known that at these low bitrates (e.g., around 10-40 kbps) several audio signals (e.g., 5) cannot be individually coded with good audio quality. Instead, the objects have to be downmixed to a few audio channels (e.g., 1 or 2) and some form of associated metadata.

Also the object signals may be accompanied with other types in the encoder. For example the sound scene may have been captured with a mobile device in a spatial audio format, an example of which is the MASA format. The spatial audio format is one in which the sound scene is represented as at least one audio signal and, for at least one time-frequency part, at least one spatial parameter (such as direction, relative energy, coherence). Thus, the spatial metadata of the spatial audio format (SAF) input (such as, for example, a MASA input) and the spatial metadata obtained from the audio objects should be compatible, so that they can be merged together at the lowest bitrates.

The methods proposed in M.-V. Laitinen, T. Pihlajamäki, C. Erkut, and V. Pulkki, “Parametric Time-frequency Representation of Spatial Sound in Virtual Worlds”, ACM TAP, 2012 could be used to create a mono audio signal and accompanying spatial metadata (direction and diffuseness parameter values in frequency bands). The mono audio signal and the spatial metadata could be transmitted and used to synthesize spatial audio with desired extent.

The approaches described above require that there are roughly as many frequency bands as there are auditory bands in human hearing (i.e., around 40-50 bands), or more. When the frequency bands are as wide as the auditory bands, or narrower, such as in high bit rate versions of the method described above then it is possible to produce natural and good sounding audio outputs.

However the same methods as described above are likely to produce artifacts in low bit rate situations (e.g., around 10-40 kbps) when it is not possible to transmit values for so many frequency bands. For example low bit rate situations may only be able to transmit values for 4-10 frequency bands.

An example of a possible artifact for such low bit rate/few frequency band implementations would be when certain frequencies are perceived as originating from a certain direction, whereas other frequencies are perceived as originating from other directions. This with only a few frequency bands produces a perception where different frequencies at different directions and can be perceived to be unpleasant to listen to, producing almost a feeling of unpleasant pressure in the listeners ears.

The embodiments discussed in detail hereafter are thus able to produce audio outputs with many narrow and few wide frequency bands and aims to produce the perception of a single wide source even in the low bit rate environment.

The concept thus as discussed in the embodiments herein is one which relates to low-bitrate encoding of object audio signals that have spatial extent (in other words the object metadata comprises parameters related to direction and spatial extent). Furthermore the embodiments comprise a method that can convert object audio signal(s) with spatial extent to a spatial audio stream (audio signal(s) and spatial time-frequency metadata) that can represent the spatial properties of such objects even with a low number of audio signals and frequency bands, and thus the stream can be encoded with a low bitrate. In some embodiments this is achieved by determining a direction parameter in frequency bands based on the object direction and extent parameters. Additionally in some embodiments there can be furthermore be determined energy ratio and coherence parameters (in the same frequency bands) that control the directional distribution of sound within those bands, determining transport audio signals, and encoding the spatial time-frequency metadata (containing the direction, energy ratio, and coherence parameters) and the transport audio signals.

In some embodiments there may be employed a large number of frequency bands or significantly fewer frequency bands (e.g., 5).

In the following examples the energy ratios parameters are described as direct-to-total energy ratios but any other suitable energy ratio may be defined and implemented/obtained. Similarly the following examples described the implementation/obtaining of spread coherence and surround coherence parameters for the coherence parameters, however any suitable coherence parameter may be obtained.

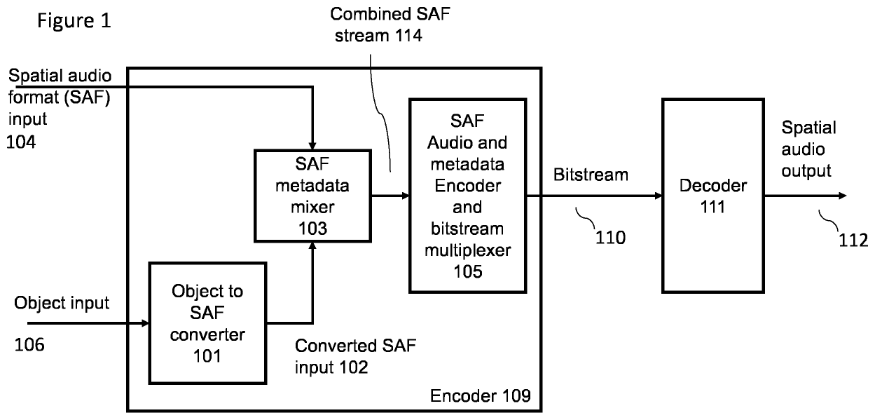

With respect to FIG. 1 is shown an example system comprising an encoder 109 suitable for implementing the embodiments as described herein. The presented system is particularly suitable at low bitrates, where transmitting the spatial audio format (such as MASA) stream and the objects separately is not possible, due to the limited number of bits available.

The example system comprises an encoder 109 configured to generate an encoded bitstream 110, which is able to be received by a suitable decoder 111. The decoder 111 is configured to generate from the bitstream 110 a spatial audio output 112 which can in some embodiments be passed to a suitable output device, such as a headset (not shown).

The encoder 109 in some embodiments is configured to receive an object input 106 (of which there is shown one of but in some embodiments may be many) and a spatial audio (for example MASA) input 104.

The encoder 109 in some embodiments comprises an object to spatial audio format (SAF) converter 101. The object to SA converter 101 is configured to receive the object input 106 can convert it into a SA format stream 102.

Additionally the encoder 109 comprises a SAF metadata mixer 103. The SAF metadata mixer 103 is configured to receive the two SAF streams (the input SAF stream and the converted SAF stream 102 created from the objects) and combine these into a combined SAF stream 114. The SAF metadata mixer 103 can in some embodiments combine the streams based on the methods shown in GB application 1808929.2.

The encoder 109 can furthermore comprise a SAF Audio and metadata Encoder and bitstream multiplexer 105. The SAF Audio and metadata Encoder and bitstream multiplexer is configured to receive the combined SAF stream 114 and encode the combined SAF stream 114 for transmission and/or storage. As the SAF Audio and metadata Encoder and bitstream multiplexer 105 input is a combined (or a single) SAF stream, it can be efficiently encoded using known SAF coding methods, without any additional parameters required for the objects. For example where the combined spatial audio format stream is a MASA format then any suitable MASA format encoder can be employed to encode the combined MASA stream. Thus, the embodiments as described herein can efficiently encode the input streams even at low bitrates.

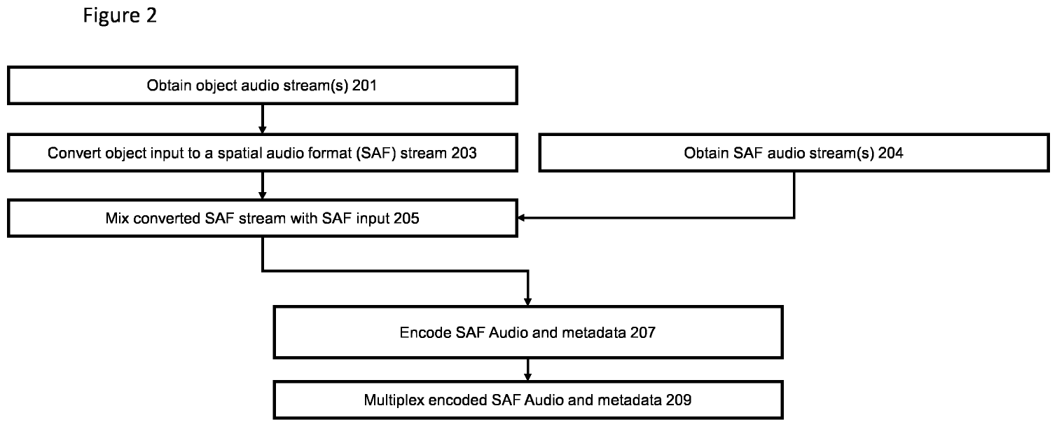

With respect to FIG. 2 is shown a flow diagram showing the operations of the example encoder 109 as shown in FIG. 1 and according to the embodiments herein.

The object audio stream(s) are obtained as shown in FIG. 2 by step 201.

The object input is then converted into a spatial audio format (SAF) stream including SAF metadata as shown in FIG. 2 by step 203. As described earlier the conversion may be to a MASA format audio stream including MASA metadata

The SAF (for example MASA) audio stream(s) can then be obtained as shown in FIG. 2 by step 204.

The obtained SAF audio stream(s) and the converted SAF audio stream(s) can then be combined to form a combined SAF audio stream as shown in FIG. 2 by step 205. In other words, the converted SAF is mixed into the SAF input stream.

Having obtained the combined SAF audio stream then the combined SAF audio stream audio signals and metadata are encoded as shown in FIG. 2 by step 207.

The encoded SAF audio stream audio signal and metadata can then be multiplexed to generate the bitstream as shown in FIG. 2 by step 209.

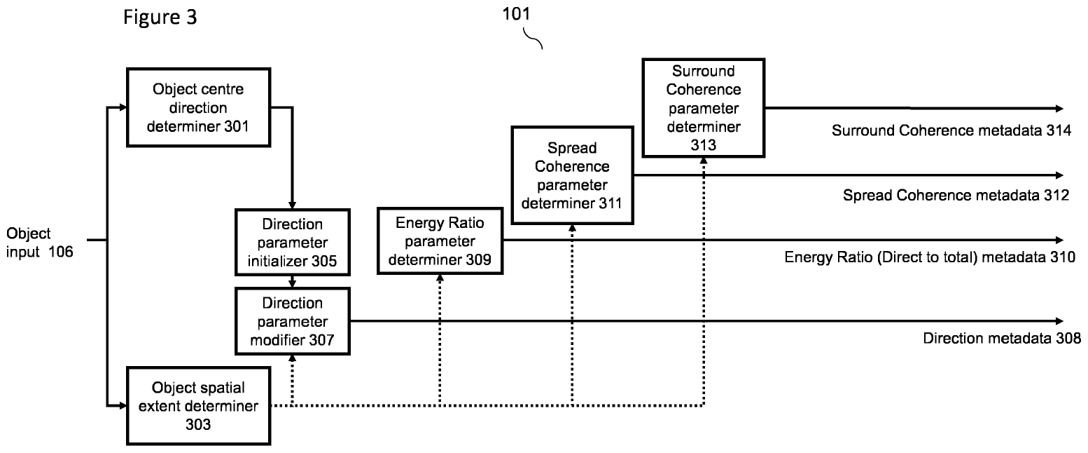

With respect to FIG. 3 is shown an example Object to SAF (for example an object to MASA format) converter 101 in further detail according to some embodiments.

The Object to SAF converter 101 is shown with an input configured to receive the object input 106.

The Object to SAF converter 101 in some embodiments comprises an object centre direction determiner 301. The object centre direction determiner 301 is configured to receive the object input 106 and determine or obtain from it the object centre (azimuth) direction θ_{c}. The example embodiment described herein discusses only the azimuth direction, as human hearing is sensitive to spatial extent mostly only in the azimuth direction. However, the presented methods could be trivially extended to the elevation direction in some further embodiments.

The Object to SAF converter 101 in some embodiments comprises an object spatial extent determiner 303. The object spatial extent determiner 303 is configured to receive the object input 106 and determine or obtain from it the object spatial extent angle θₑₓₜ.

The SAF metadata to be output may comprise the following parameters (in a time-frequency domain): (azimuth) direction θ, direct-to-total energy ratio r_{dir}, spread coherence ζ, and surround coherence γ. In other embodiments, some other parameters can be used instead of or in addition to these parameters.

In some embodiments the Object to SAF converter 101 comprises a Direction parameter initializer 305. The Direction parameter initializer 305 is configured to determine an initial direction parameter value based on the object centre direction parameter. For example in some embodiments the Direction parameter initializer 305 is configured to assume that the object is a point source and set the initial direction parameter value to the object centre direction parameter value. In other words the Direction parameter initializer 305 is configured to set the direction parameter (azimuth) for n the temporal frame and k the frequency band index as:

θᵢₙᵢₜ(n,k)=θ_{c}(n)

The Object to SAF converter 101 may further comprise a direction parameter modifier 307. The direction parameter modifier 307 is configured to receive the initial estimate and further receive the object spatial extent angle θₑₓₜ. The direction parameter modifier 307 is configured to modify the initial direction parameter value θᵢₙᵢₜ (n, k) based on the extent parameter value θₑₓₜ, the initial direction parameter is modified by applying a random or pseudorandom fluctuation.

In some embodiments the fluctuation is applied based on the disclosures of M.-V. Laitinen, T. Pihlajamäki, C. Erkut, and V. Pulkki, “Parametric Time-frequency Representation of Spatial Sound in Virtual Worlds”, ACM TAP, 2012 or T. Pihlajamäki, O. Santala, and V. Pulkki, “Synthesis of Spatially Extended Virtual Sources with Time-Frequency Decomposition of Mono Signals”, Journal of AES, 2014.

In some embodiments the maximum angle of direction change due to the fluctuation may be limited to a fraction of the current extent angle. This is implemented as there may be only a few frequency bands (e.g., 5), and thus the frequency bands are wide. With such wide frequency bands, large fluctuations in the directions would cause perceivable artefacts. In order to avoid those artefacts, the fluctuations are limited to a smaller range.

For example in some embodiments the direction parameter modifier 307 is configured to implement the following

$$\begin{matrix}θ ( n , k ) = {θ}_{init} ( n , k ) + {θ}_{Δ} ( n , k ) \\ {θ}_{Δ} ( n , k ) = {c}_{θ} min ( 1 , \frac{{θ}_{ext} ( n )}{{c}_{θ}} ) 𝒰 ( - 1 , 1 )\end{matrix}$$

where θₑₓₜ (n) is the extent angle (range 0-180), c_{θ} is a constant for controlling maximum direction fluctuation (e.g., with value of 60), θᵢₙᵢₜ (n, k) is the initial direction (which is also the centre direction), θ_{Δ} (n, k) is the direction fluctuation value, [symbol] (−1,1) is a uniform random variable between −1 and 1 or other suitable random or pseudo-random value, and θ(n, k) is the resulting modified (MASA) direction value that contains suitable fluctuation. It is noted that using a value 180 for extent angle allows a sound to have full extent, in other words, a sound that is completely surrounding.

In some embodiments the direction parameter modifier 307 is configured to implement an alternative θ_{Δ}(n, k) determination

$${θ}_{Δ} ( n , k ) = \frac{{c}_{θ} {θ}_{e x t} ( n )}{180} 𝒰 ( - i , 1 ) .$$

The direction metadata 308 comprising θ(n, k), the resulting modified (MASA) direction value, can then be output.

In some embodiments the Object to SAF converter 101 comprises an Energy Ratio parameter determiner 309. The Energy Ratio parameter determiner 309 is configured to receive the object spatial extent angle θₑₓₜ values and determine energy ratios. For example in some embodiments the Energy Ratio parameter determiner 309 is configured to determine a direct-to-total ratio r_{dir} in such way that the direct-to-total value decreases when the extent increases. For example in some embodiments the value decrease is a linear one, for example:

$${r}_{d i r} ( n , k ) = 1 - \frac{{θ}_{ext}}{180}$$

In some embodiments the decrease profile can be other than linear.

In such a manner the energy ratio can have the value of r_{dir}(n, k)=1 when the spatial extent is zero θₑₓₜ=0 and r_{dir}(n, k)=0 when the spatial extent is 180 θₑₓₜ=180.

The energy ratio (Direct-to-total) metadata 310 comprising rₐᵢᵣ(n, k), the direct-to-total energy ratio value, can then be output.

In some embodiments the Object to SAF converter 101 comprises a spread coherence parameter determiner 311. The spread coherence parameter determiner 311 is configured to receive the object spatial extent angle θₑₓₜ values and determine spread coherence values. For example in some embodiments the spread coherence parameter determiner 311 is configured to determine a spread coherence value ζ, such that the spread coherence is increased with the extent value and clamped to a maximum of 0.5. This for example can be implemented based on the following equation:

$$ξ ( n , k ) = \{ \begin{matrix}\frac{{θ}_{ext}}{60} 0 \text{.5} , & when {θ}_{ext} \leq 60 \\ 0.5 , & when {θ}_{ext} > 60\end{matrix}$$

In some embodiments the increasing profile can be other than linear.

In such a manner the spread coherence can have the value of ζ(n, k)=0 when the spatial extent is zero θₑₓₜ=0 and ζ(n, k)=0.5 when the spatial extent is 60 or greater.

The spread coherence metadata 312 comprising ζ(n, k), the spread coherence value, can then be output.

In some embodiments the Object to SAF converter 101 comprises a surround coherence parameter determiner 313. The surround coherence parameter determiner 313 is configured to receive the object spatial extent angle θₑₓₜ values and determine surround coherence values. For example in some embodiments the surround coherence parameter determiner 313 is configured to determine a surround coherence value γ such that the surround coherence is also increased with the extent value. This for example can be implemented based on the following equation:

$$γ ( n , k ) = \frac{{θ}_{ext}}{180} 0.5$$

In some embodiments the increasing profile can be other than linear.

In such a manner the surround coherence can have the value of γ(n, k)=0 when the spatial extent is zero θₑₓₜ=0 and γ(n, k)=0.5 when the spatial extent is 180.

The surround coherence metadata 314 comprising γ(n, k) the surround coherence value, can then be output.

In such a manner the metadata parameters can be mixed and encoded in such a manner that a rendered output when the parameters are processed through IVAS MASA encoding and decoding (or any suitable spatial audio codec) produces good quality audio output even where the bit rates are low.

As discussed above the equation where linear extent angle dependency is presented (for example in the form

$$\frac{{θ}_{e x t}}{N} )$$

can be replaced using some other relation than linear. For example the dependency could be one such as

$${( \frac{{θ}_{e x t}}{N} )}^{β} ,$$

where β is a curve form parameter. Each formed parameter may also have a different curve form parameter. In addition, the limits found in the above equations (e.g., in spread coherence) are suitable examples and other values could also be used.

In addition to generation or conversion of metadata parameters, the object audio signal(s) are converted in some embodiments to generate a converted or suitable downmix audio signal. In some embodiments the converted audio signal(s) can be generated in a way that amplitude panning gains are computed according to the edges of the extent and the panning gains are then averaged over these two directions. This enables that there is always signal in the (downmix) audio signals within the extent, and thus the synthesis algorithm is able to synthesize the desired extent. This may be done until the edges are angular opposite (extent=) 90° of each other. For extent angles larger than 90°, the edges corresponding to 90° extent should be used.

In some embodiments during onsets, it is possible to set all frequencies to the same direction. This allows in some embodiments a production of perceptually more “crispy” onsets. In addition, the directions of these broadband events may be wider than otherwise (in other words the angular difference compared to the centre direction is larger), thus making the perceived extent wider.

With respect to direction parameter fluctuation, although the distributed directions should be relatively stable to avoid artifacts, more fluctuation increases the perceived extent as the individual spectral components have less clear directions. In some embodiments, for a low bitrate representation, static fluctuation values are set that cover the angular range, in other words the application of the random variable [symbol] (−1,1) is not really random but deterministic. Alternatively, controlled random or pseudorandom distributions can be employed in some embodiments.

In some embodiments the fluctuation values of the direction can be changed during the onset, when all the directions are set to the same direction. This may make the sound scene more natural, as the listener cannot perceive any direction to dominate any frequency. Similarly, a fluctuation value of a direction (one or more frequency bands at a time) may be changed when one or more (or all) frequency bands are silent (i.e., have very low energy). In some embodiments would involve the switching of the fluctuation values of two silent bands.

The output of this converter 101 is a MASA format stream which follows the MASA specification. Thus, the output can be mixed, encoded, decoded, and rendered as a normal MASA format stream.

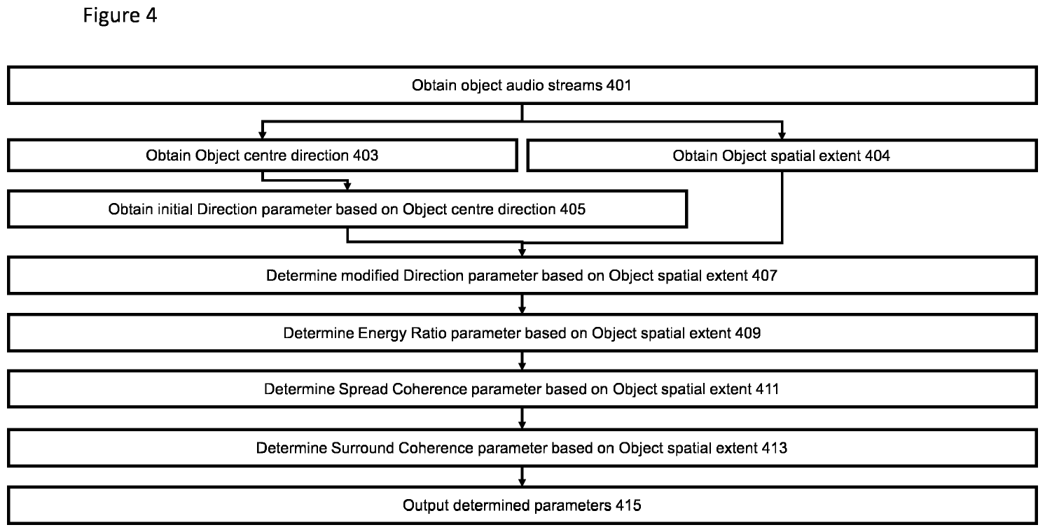

With respect to FIG. 4 is shown a flow diagram showing the operations of the example converter shown in FIG. 3 according to some embodiments.

Thus the object audio streams are obtained as shown in FIG. 4 by step 401.

The object centre direction parameter is determined or otherwise obtained as shown in FIG. 4 by step 403.

The object spatial extent parameter is determined or otherwise obtained as shown in FIG. 4 by step 404.

Having obtained the object centre direction parameter, an initial direction parameter is determined as shown in FIG. 4 by step 405.

Furthermore after determining the initial direction parameter a modified direction parameter is determined based on the object spatial extent parameter as shown in FIG. 4 by step 407.

Then an energy ratio parameter is determined based on the object spatial extent parameter as shown in FIG. 4 by step 409.

A spread coherence parameter is then determined based on the object spatial extent parameter as shown in FIG. 4 by step 411.

A surround coherence parameter is furthermore determined based on the object spatial extent parameter as shown in FIG. 4 by step 413.

The determined parameters can then be output as shown in FIG. 4 by step 415.

The embodiments presented above show a single spatially extended object. However, there may be multiple objects present in a single sound scene and part of these can be point-like and part spatially extended. In some embodiments therefore a following approach may be implemented.

1. Divide objects to two groups based on if they are spatially extended or point-like.

2. Synthesize point-like objects into an FOA signal and analyze the resulting FOA signal:
a. First, convert each separate object to an FOA signal with equation

$${FOA}_{i} ( t ) = [ \begin{matrix}{w}_{i} ( t ) \\ {x}_{i} ( t ) \\ {y}_{i} ( t ) \\ {z}_{i} ( t )\end{matrix} ] = {s}_{i} ( t ) [ \begin{matrix}1 \\ cos ( {azi}_{i} ) cos ( {ele}_{i} ) \\ sin ( {azi}_{i} ) cos ( {ele}_{i} ) \\ sin ( {ele}_{i} )\end{matrix} ]$$

b. Then, sum separate FOA signals together to form combined FOA signal with all point-like objects. Transform this signal to time-frequency domain. In some embodiments the FOA generation can be performed in the time-frequency domain.
c. Estimate intensity-related variable from the time-frequency domain FOA signal (where Re means taking the real part).

$$I ( n , k ) = Re \{ {w}^{*} ( n , k ) [ \begin{matrix}x ( n , k ) \\ y ( n , k ) \\ z ( n , k )\end{matrix} ] \}$$

d. Determine direction and ratio parameters (where E means expectation operator and atan operator is the computational variant that solves the correct quadrant automatically), coherence parameters can be set to zero.

$$\begin{matrix}θ ( n , k ) = ( \frac{{I}_{y} ( n , k )}{{I}_{x} ( n , k )} ) \\ {r}_{d i r} ( n , k ) = \frac{\vert E [ I ( n , k ) ] \vert}{E [ 0.5 ( {w}^{2} ( n , k ) + {x}^{2} ( n , k ) + {y}^{2} ( n , k ) + {z}^{2} ( n , k ) ) ]} \\ ξ ( n , k ) = 0 \\ γ ( n , k ) = 0\end{matrix}$$

In case of having a single point-like object, the following equations can be used instead:

θ(n,k)=θ_{c}(n)

r_{dir}(n,k)=1

ζ(n,k)=0

γ(n,k)=0

3. Generate MASA metadata separately for each spatially extended object using the above operations

$$\begin{matrix}θ ( n , k ) = {θ}_{c} ( n ) + {θ}_{Δ} ( n , k ) \\ {r}_{d i r} ( n , k ) = 1 - \frac{{θ}_{ext}}{180} \\ ξ ( n , k ) = \{ \begin{matrix}\frac{{θ}_{ext}}{60} 0 \text{.5} , & when {θ}_{ext} \leq 60 \\ 0.5 , & when {θ}_{ext} > 60\end{matrix} \\ γ ( n , k ) = \frac{{θ}_{ext}}{180} 0.5\end{matrix}$$

4. Combine the SAF (such as MASA format) metadata streams from the point-like objects and the spatially extended objects together into one set of SAF metadata. For example by using the metadata merging strategy presented in UKIPO patent applications 1919130.3 and 1919131.1. In some embodiments this can mean joining on TF-tile basis, direction and direct-to-total ratio with a vector sum and averaging other parameters.

This SAF stream can then be merged with the input SAF stream as presented above. It should be noted that the merging strategy presented above is merely one example, and other methods can be used in other embodiments.

As SAF (for example MASA format) metadata supports multiple concurrent directions, where the use case allows this (i.e., bitrate does not limit it), then the generated metadata for a spatially extended source can be adapted for this in some embodiments. One option in such embodiments is to simply create two sets of parameters where the fluctuated directions are complementary for the two concurrent directions. This can be implemented such that, if first direction is on the left side, then the second direction could be on the right. The other parameter curves can then be adjusted for this change. Any other similar solution could be employed in some other embodiments. In some embodiments for two concurrent directions the apparatus could be configured to signal within the metadata that the two concurrent directions should be mutually incoherent. This means that one or both of the prototype signals in synthesis could be decorrelated and resulting rendering would be similar to the “mirror method” presented in T. Pihlajamäki, O. Santala, and V. Pulkki, “Synthesis of Spatially Extended Virtual Sources with Time-Frequency Decomposition of Mono Signals”, Journal of AES, 2014.

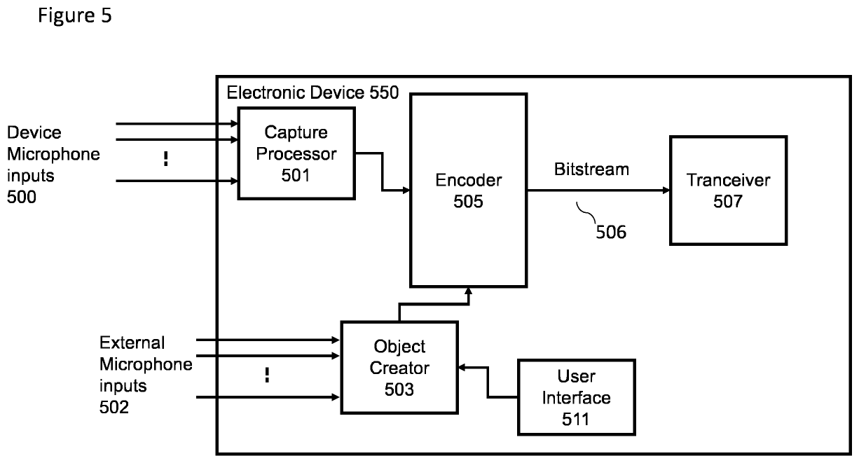

With respect to FIG. 5 is shown an example apparatus or electronic device suitable for implementing some embodiments (which in this example is a MASA format spatial audio output but in some embodiments be any suitable spatial audio format). The electronic device 550 is configured to capture spatial audio signals, encode the spatial audio signals, and transmit the spatial audio signals to another device (for storage or rendering). The apparatus can, for example be a mobile device.

In this example device the device has microphones attached to it (forming a microphone array) and generating suitable device microphone inputs 500. The device microphone inputs 500 signals (from these device microphones) are forwarded to a capture processor 501. The capture processor 501 is configured to perform analysis on the microphone-array signals (e.g., using methods presented in GB published U.S. Pat. No. 2,556,093), and forms a suitable MASA stream as an output to be passed to the encoder 505.

In addition, external microphone(s) are connected to the apparatus, for example, using Bluetooth, or wired connection. The signals from the external microphones form the external microphone inputs 502 and are forwarded to an Object creator 503.

In addition, the Object creator 503 is configured to receive control data from an user interface 511. For example the user may use the user interface 511 to set the desired direction and spatial extent for each object. The control data in some embodiments contains information on these desired object properties. The object creator 503 is configured to create an object stream by obtaining/attaching suitable metadata for each audio signal based on the control data (for example by setting the direction and the spatial extent parameters for each object). The object stream is the output of the object creator 503.

The MASA stream and the Object stream are forwarded to an encoder 505. The encoder 505 is configured to encode the streams. The encoder 505 can be implemented in the manner shown in FIG. 1, and the corresponding text. The resulting bitstream 506 is forwarded to a transceiver 507, which can be configured to transmit the bitstream 506 to another device. The bitstream can, for example, be an IVAS bitstream, and the transmission can, for example, be performed using the 5G network. The other device can then receive, decode, and render the spatial audio using the bitstream.

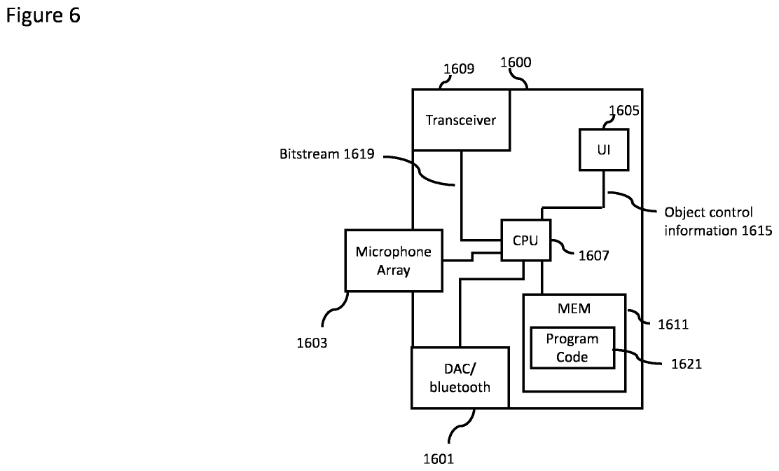

With respect to FIG. 6 an example electronic device which may be used as the encoder or any of the functional blocks described herein is shown. The device may be any suitable electronics device or apparatus. For example in some embodiments the device 1600 is a mobile device, user equipment, tablet computer, computer, audio playback apparatus, etc.

In some embodiments the device 1600 comprises at least one processor or central processing unit 1607. The processor 1607 can be configured to execute various program codes such as the methods such as described herein.

The device 1600 comprises a DAC/Bluetooth input 1601 configured to receive external microphone inputs which can be passed to the processor (CPU) 1607.

The device 1600 further comprises a microphone array 1603 configured to generate the device microphone inputs which can be passed to the processor (CPU) 1607.

In some embodiments the device 1600 comprises a memory 1611. In some embodiments the at least one processor 1607 is coupled to the memory 1611. The memory 1611 can be any suitable storage means. In some embodiments the memory 1611 comprises a program code section for storing program codes implementable upon the processor 1607. Furthermore in some embodiments the memory 1611 can further comprise a stored data section for storing data, for example data that has been processed or to be processed in accordance with the embodiments as described herein. The implemented program code stored within the program code section 1621 and the data stored within the stored data section can be retrieved by the processor 1607 whenever needed via the memory-processor coupling.

In some embodiments the device 1600 comprises a user interface 1605. The user interface 1605 can be coupled in some embodiments to the processor 1607. In some embodiments the processor 1607 can control the operation of the user interface 1605 and receive inputs from the user interface 1605. In some embodiments the user interface 1605 can enable a user to input commands to the device 1600, for example via a keypad. In some embodiments the user interface 1605 can enable the user to obtain information from the device 1600. For example the user interface 1605 may comprise a display configured to display information from the device 1600 to the user. The user interface 1605 can in some embodiments comprise a touch screen or touch interface capable of both enabling information to be entered to the device 1600 and further displaying information to the user of the device 1600.

In some embodiments the device 1600 comprises a transceiver 1609. The transceiver in such embodiments can be coupled to the processor 1607 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

The transceiver input/output port 1609 may be configured to transmit/receive the audio signals, the bitstream and in some embodiments perform the operations and methods as described above by using the processor 1607 executing suitable code.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media, and optical media.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. An apparatus, for spatial audio encoding, the apparatus comprising:
at least one processor; and
at least one non-transitory memory storing instructions that, when executed with the at least one processor, cause the apparatus at least to:
obtain a first spatial audio stream of a first spatial audio format configured to be encoded with a low bitrate, wherein the first spatial audio stream comprises at least one audio signal and at least one first metadata;
obtain a second spatial audio stream of a second spatial audio format, the second spatial audio format being different from the first spatial audio format, wherein the second spatial audio stream comprises at least one second audio signal and at least one second metadata;
convert the second spatial audio format into the first spatial audio format so as to encode a converted second spatial audio stream with the low bitrate, wherein the converted spatial audio stream, at least in part, represents spatial audio properties of the second spatial audio stream;
combine the first spatial audio stream and the converted second spatial audio stream so as to generate a combined spatial audio stream for encoding with the low bitrate; and
encode the combined spatial audio stream.

2. The apparatus as claimed in claim 1, wherein the first spatial audio format is a metadata assisted spatial audio format, and wherein the at least one first metadata is at least one spatial parameter comprising at least one of:
at least one direction parameter:
at least one energy ratio parameter; or
at least one coherence parameter.

3. (canceled)

4. The apparatus as claimed in claim 2, wherein the apparatus comprises at least two microphones, and the instructions, when executed with the at least one processor, cause the apparatus to obtain the first spatial audio stream of the first spatial audio format and to generate the first spatial audio stream of the first spatial audio format based on at least two microphone audio signals from the at least two microphones.

5. The apparatus as claimed in claim 1, wherein the second spatial audio format is an object audio format, and wherein the at least one second metadata is at least one object spatial parameter.

6. The apparatus as claimed in claim 5, wherein the at least one object spatial parameter comprises at least one of:
at least one object direction parameter;
at least one object energy ratio parameter; or
at least one object spatial extent parameter.

7. The apparatus as claimed in claim 5, wherein the instructions, when executed with the at least one processor, cause the apparatus to receive at least one external microphone audio signal, and wherein the instructions, when executed with the at least one processor, further cause the apparatus to obtain the second spatial audio stream of the second spatial audio format to generate the second spatial audio stream based on the at least one external microphone audio signal.

8. The apparatus as claimed in claim 5, wherein the instructions, when executed with the at least one processor, cause the apparatus to convert the second spatial audio format into the first spatial audio format to cause the apparatus to at least one of:
determine whether the second spatial audio stream of the second spatial audio format has a spatial extent; or
convert the second spatial audio format into the first spatial audio format based on the determination of whether the second spatial audio stream of the second spatial audio format has a spatial extent.

9. The apparatus as claimed in claim 8, wherein the second instructions, when executed with the at least one processor, cause the apparatus to convert the second spatial audio format into the first spatial audio format and further cause the apparatus to at least one of:
obtain an initial converted first spatial audio format direction parameter based on an object direction parameter from the second spatial audio format; or
modify the initial converted first spatial audio format direction parameter to generate a converted first audio format direction parameter based on the spatial extent from the second spatial audio stream.

10. The apparatus as claimed in claim 9, wherein the instructions, when executed with the at least one processor, cause the apparatus to modify the initial converted first spatial audio format direction parameter to generate the converted first audio format direction parameter and further cause the apparatus to determine the converted first audio format direction parameter based on modification angle applied to the initial converted first spatial audio format direction parameter, wherein the modification angle is based on an extent angle of the spatial extent, a direction fluctuation constant, and a random or pseudo-random distribution generated value.

11. The apparatus as claimed in claim 9, wherein the instructions, when executed with the at least one processor, cause the apparatus to convert the second spatial audio format into the first spatial audio format and further cause the apparatus to obtain a converted first spatial audio format energy ratio parameter based on the spatial extent from the second spatial audio stream.

12. The apparatus as claimed in claim 11, wherein the instructions, when executed with the at least one processor, cause the apparatus to obtain the converted first spatial audio format energy ratio parameter and further cause the apparatus to determine the converted first spatial audio format energy ratio parameter based on a decrease profile generated by a ratio between an extent angle of the spatial extent and an extent angle limit.

13. The apparatus as claimed in claim 9, wherein the instructions, when executed with the at least one processor, cause the apparatus to convert the second spatial audio format into the first spatial audio format and further cause the apparatus to obtain a converted first spatial audio format coherence parameter based on the spatial extent from the second spatial audio stream.

14. The apparatus as claimed in claim 13, wherein the instructions, when executed with the at least one processor, cause the apparatus to obtain the converted first spatial audio format coherence parameter and further cause the apparatus to at least one of:
determine a spread coherence parameter, such that the spread coherence parameter is increased based on an extent angle of the spatial extent and clamped to a maximum value; or
determine a surround coherence parameter, such that the surround coherence parameter is increased based on an extent angle of the spatial extent.

15. (canceled)

16. The apparatus as claimed in claim 8, wherein the second spatial audio stream of the second spatial audio format has no spatial extent or is a point-like object and the instructions, when executed with the at least one processor, cause the apparatus to convert the second spatial audio format into the first spatial audio format and further cause the apparatus to at least one of:
generate a first order ambisonic audio signal from the at least one second audio signal and the at least one second metadata, wherein the at least one second format audio signal is a point-like object audio signal and the at least one second metadata is a point-like object direction parameter; or
analyze the first order ambisonic audio signal.

17. The apparatus as claimed in claim 16, wherein the instructions, when executed with the at least one processor, cause the apparatus to generate the first order ambisonic audio signal and further cause the apparatus to at least one of:
convert each separate point-like object to separate first order ambisonic audio signals; or
sum the separate first order ambisonic audio signals together to form a combined first order ambisonic audio signal.

18. The apparatus as claimed in claim 17, wherein the instructions, when executed with the at least one processor, cause the apparatus to analyze the first order ambisonic audio signal and further cause the apparatus to at least one of:
determine an intensity-related variable from the combined first order ambisonic audio signal;
determine a converted first spatial audio format direction parameter direction parameter based on the intensity-related variable;
determine a converted first spatial audio format energy ratio parameter based on the intensity-related variable and the combined first order ambisonic audio signal;
set a converted first spatial audio format spread coherence parameter to zero; or
set a converted first spatial audio format surround coherence parameter to zero.

19. The apparatus as claimed in claim 8, wherein the second spatial audio stream of the second spatial audio format is a single point-like object and the instructions, when executed with the at least one processor, cause the apparatus to convert the second spatial audio format into the first spatial audio format and further cause the apparatus to at least one of:
set a converted first spatial audio format direction parameter direction parameter to a single point-like object at least one direction parameter;
set a converted first spatial audio format energy ratio parameter to one;
set a converted first spatial audio format spread coherence parameter to zero; or
set a converted first spatial audio format surround coherence parameter to zero.

20. The apparatus as claimed in claim 1, wherein the instructions, when executed with the at least one processor, cause the apparatus to combine the first spatial audio stream and the converted second spatial audio stream so as to generate a combined spatial audio stream for encoding with the low bitrate to mix the first spatial audio stream and the converted second spatial audio stream.

21. The apparatus as claimed in claim 1, wherein the instructions, when executed with the at least one processor, cause the apparatus to transmit the encoded combined spatial audio stream.

22. A method for an apparatus for spatial audio encoding, the method comprising:
obtaining a first spatial audio stream of a first spatial audio format configured to be encoded with a low bitrate, wherein the first spatial audio stream comprises at least one audio signal and at least one first metadata;
obtaining a second spatial audio stream of a second spatial audio format, the second spatial audio format being different from the first spatial audio format, wherein the second spatial audio stream comprises at least one second audio signal and at least one second metadata;
converting the second spatial audio format into the first spatial audio format so as to encode a converted second spatial audio stream with the low bitrate, wherein the converted spatial audio stream, at least in part, represents spatial audio properties of the second spatial audio stream;
combining the first spatial audio stream and the converted second spatial audio stream so as to generate a combined spatial audio stream for encoding with the low bitrate; and
encoding the combined spatial audio stream.

23. (canceled)
